(19) United States
(12) Patent Application Publication
(10) Pub. No.: US 2008/0079705 A1
(43) Pub. Date: Apr. 3, 2008

(54) LIGHT SOURCE SYSTEM WITH LEDs AND DRIVING METHOD THEREOF

(76) Inventors: Chien-Yi Yang, Hsinchu (TW); Po-Hsiang Huang, Hsinchu (TW); Cheng-Yang Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/782,643

(22) Filed: Jul. 25, 2007

(30) Foreign Application Priority Data
Sep. 28, 2006 (TW) 095135975

(51) Int. Cl. G06F 3/038; G09G 5/10

(52) U.S. Cl. 345/207; 345/691

(57) ABSTRACT

A driving method includes setting resistances of resistors in three driving circuits according to maximum tolerable currents corresponding to RGB LEDs respectively, using a PWM module to drive the RGB LEDs respectively in turn with a frequency higher than a visual persistence frequency, using a light sensor to detect light generated by the RGB LEDs and to output a detecting signal, and controlling the PWM module to adjust a luminous intensity of at least one LED in the RGB LEDs according to the detecting signal.

### BACKGROUND OF THE INVENTION

1. Field of the Invention

The present invention relates to a light source system, and more specifically, to a light source system with LEDs and a driving method thereof.

2. Description of the Prior Art

At present, projectors are mostly used during meetings and conferences. Reports or charts can be projected on a display screen by the projector. As a result, using the projector to present a report makes information offered by the report clearly understandable to people attending the conference. With the application of LEDs (Light Emitting Diodes), projectors have become much smaller and lighter.

In general, a three-phase signal is used by a projector utilizing RGB (Red, Green, Blue) LEDs as light source to drive RGB LEDs respectively in turn with a frequency higher than a visual persistence frequency. The light source of the projector is switched between RGB LEDs at a high speed, which is fast enough to make effective use of the phenomenon of visual persistence, to blend the lights as perceived by the eye, so that the projector projectors color images.

The prior art method involves driving a red LED, a green LED, and a blue LED respectively by means of three sets of driving circuits. Please refer to FIG. 1. Each driving circuit 10 comprises a resistor 12 and an LED 14. Current flowing into the LED 14 to drive the LED 14 is determined based on the magnitude of the resistance of the resistor 12.

Please refer to FIG. 2. The driving circuit 10 controls the three sets of driving circuits according to three-phase Pulse Width Modulator (PWM) signal as shown in FIG. 2, and drive the red LED, the green LED, and the blue LED in turn to emit lights. Hatched blocks as shown in FIG. 2 are light-emitting sections (T₁, T₂, T₃) for corresponding LED. For example, during time period T₁ when the red LED of the RGB LEDs is on, only the driving circuit of the red LED operates. That is to say, only the red LED emits light. During time period T₂ when the green LED of the RGB LEDs is on, only the driving circuit of the green LED operates. That is to say, only the green LED emits light. And during time period T₃ when the blue LED of the RGB LEDs is on, only the driving circuit of the blue LED operates. That is to say, only the blue LED emits light. In such a manner, the red LED, the green LED, and the blue LED emit light in turn according to the PWM signal.

When the color balance or brightness of the light source is not good and needs to be adjusted, changing the resistance of the resistor is the prior art method for the brightness adjustment of the LED 14. However, being a fixed resistor, the resistor 12 needs to be replaced for changing the resistance. In addition, all three sets of driving circuits respectively corresponding to the red LED, the green LED and the blue LED have distinctive characteristics, which increases the difficulty in changing the resistor. Moreover, if the resistance of the resistor needed to be replaced is a special and precise resistance, it gets more difficult to obtain such a resistor. Although a digital variable resistor can be used to solve the problem mentioned above, it is expensive and then will increase the manufacturing cost.

### SUMMARY OF THE INVENTION

The present invention provides a light source system and a driving method thereof for solving the problem mentioned above.

The present invention discloses a driving method for a light source system with LEDs comprising setting resistances of resistors in three driving circuits according to maximum tolerable currents corresponding to RGB LEDs respectively, using a PWM module to drive the RGB LEDs respectively in turn with a frequency higher than a visual persistence frequency, using a light sensor to detect light generated by the RGB LEDs and to output a detecting signal, and controlling the PWM module to adjust a luminous intensity of at least one LED in the RGB LEDs according to the detecting signal.

The present further discloses a light source system comprising a power switch board, an LED control board, a PWM module, a system control board, and a light sensor, wherein the power switch board is used for supplying power; the LED control board is electrically connected to the power switch board; the LED control board comprises a plurality of LEDs and a plurality of driving circuits, each driving circuit being used to input current into the corresponding LED for driving the plurality of LEDs; the PWM module is electrically connected to the LED control board for outputting a PWM signal to the LED control board; the system control board is electrically connected to the PWM module for controlling the PWM module to adjust the pulse width of the PWM signal; the light sensor is electrically connected to the system control board for detecting light generated by the plurality of LEDs and outputting a detecting signal to the system control board, the system control board controlling the PWM module to adjust the pulse width of the PWM signal according to the detecting signal.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a diagram of a conventional LED driving circuit.

FIG. 2 is a diagram of a conventional PWM signal.

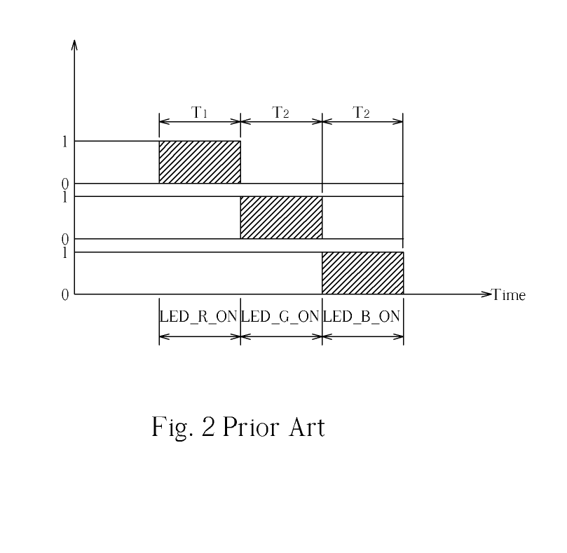

FIG. 3 is a functional block diagram of a light source system according to an embodiment of the present invention.

FIG. 4 is a flowchart of a driving method applied for the light source system in FIG. 3.

FIG. 5 is a diagram of a PWM signal according to an embodiment of the present invention.

### DETAILED DESCRIPTION

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

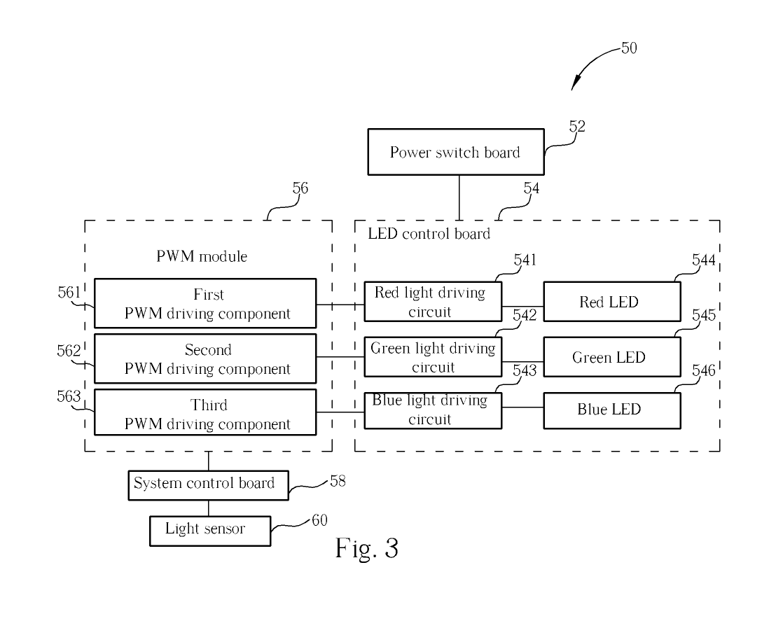

Please refer to FIG. 3. FIG. 3 is a diagram of a light source system 50 according to an embodiment of the present invention. The light source system 50 comprises a power switch board 52, an LED control board 54, a PWM module 56, a system control board 58 and a light sensor 60.

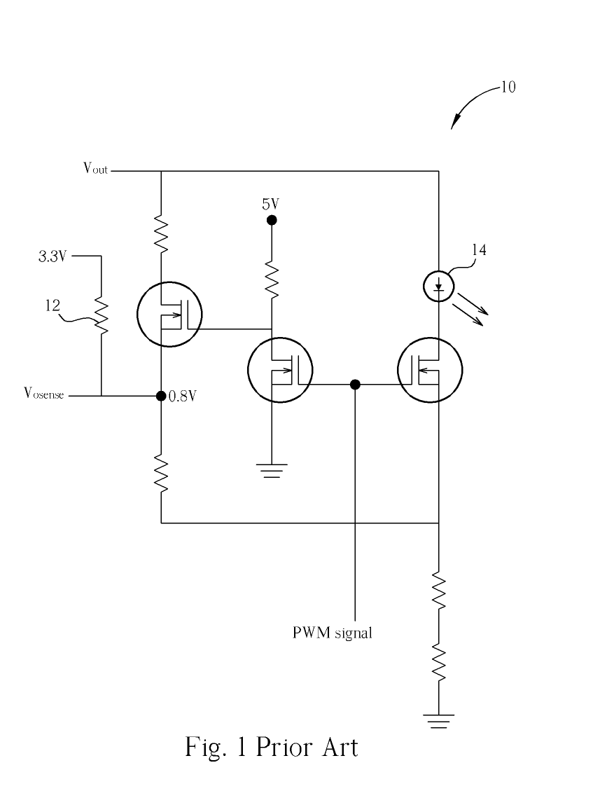

The power switch board 52 is used for supplying power. The LED control board 54 is electrically connected to the power switch board 52. The LED control board 54 comprises a red LED 544, a green LED 545, a blue LED 546, a red light driving circuit 541, a green light driving circuit 542, and a blue light driving circuit 543. The red LED 544 is electrically connected to the red light driving circuit 541. The red light driving circuit 541 is used to input current into the red LED 544 for driving the red LED 544 to emit red light. The green LED 545 is electrically connected to the green light driving circuit 542. The green light driving circuit 542 is used to input current into the green LED 545 for driving the green LED 545 to emit green light. The blue LED 546 is electrically connected to the blue light driving circuit 543. The blue light driving circuit 543 is used to input current into the blue LED 546 for driving the blue LED 546 to emit blue light. The diagrams of the red, green, and blue driving circuits 541, 542, and 543 are like the driving circuit 10 as shown in FIG. 1, and the detail description thereof is omitted for the sake of convenience and simplicity. The red LED 544, the green LED 545, and the blue LED 546 can be Power LEDs. Each driving circuit comprises a resistor for controlling the magnitude of current flowing into the corresponding LED. The resistance of the resistor is set according to the maximum tolerable current of the corresponding LED.

The PWM module 56 is electrically connected to the LED control board 54 for outputting a PWM signal to the LED control board 54. The PWM signal comprises a red light pulse signal, a green light pulse signal, and a blue light pulse signal. The PWM module 56 comprises a first PWM driving component 561, a second PWM driving component 562, and a third PWM driving component 563. The first PWM driving component 561 is used for generating the red light pulse signal. The second PWM driving component 562 is used for generating the green light pulse signal. The third PWM driving component 563 is used for generating the blue light pulse signal.

The system control board 58 is electrically connected to the PWM module 56 for controlling the PWM module 56 to adjust the pulse width of the PWM signal. The system control board 58 can be an OSD (On Screen Display) device.

The light sensor 60 is electrically connected to the system control board 58 for detecting light generated by the LED control board 54 and outputting a detecting signal to the system control board 58 based on the color temperatures of the detected light. The color temperatures detected by the light sensor 60 can be displayed by the system control board 58. The luminous intensity of the detected light can be calculated through the detected color temperatures according to the proportion relationship between a color temperature and a luminous intensity.

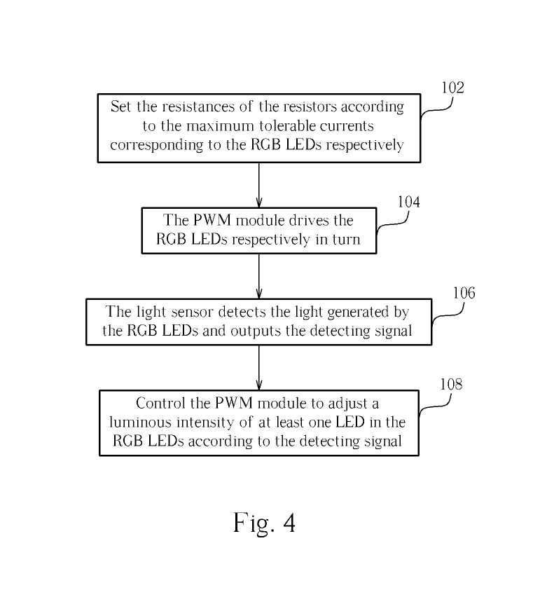

Please refer to FIG. 4. FIG. 4 is a flowchart of a driving method applied for the light source system 50 in FIG. 3. The driving method comprises the following steps: setting resistances of resistors in three driving circuits according to maximum tolerable currents corresponding to RGB LEDs (as shown in Step 102) respectively, using a PWM module 56 to drive the RGB LEDs (red LED 544, green LED 546, and blue LED 548) by time division driving (as shown in Step 104), using a light sensor 60 to detect light generated by the RGB LEDs and to output a detecting signal (as shown in Step 106), and controlling the PWM module 56 to adjust the luminous intensity of at least one LED in the RGB LEDs according to the detecting signal from the light sensor 60 (as shown in Step 108).

In Step 102, setting resistances of resistors in three driving circuits according to the maximum tolerable currents corresponding to RGB LEDs respectively involves setting resistances of resistors in three driving circuits according to the maximum tolerable currents corresponding to the red LED 544, the green LED 545, and the blue LED 546 respectively.

In Step 104, the time division driving entails driving the RGB LEDs respectively in turn with a frequency higher than a visual persistence frequency, so as to switch between the RGB LEDs at a high speed to blend the lights as perceived by the eye for generating color images.

In Step 106, the light sensor 60 detects the color temperatures of the light generated by the red LED 544, the green LED 545, and the blue LED 546, and outputs a corresponding detecting signal in accordance with the color temperatures for adjustment of color balance or brightness.

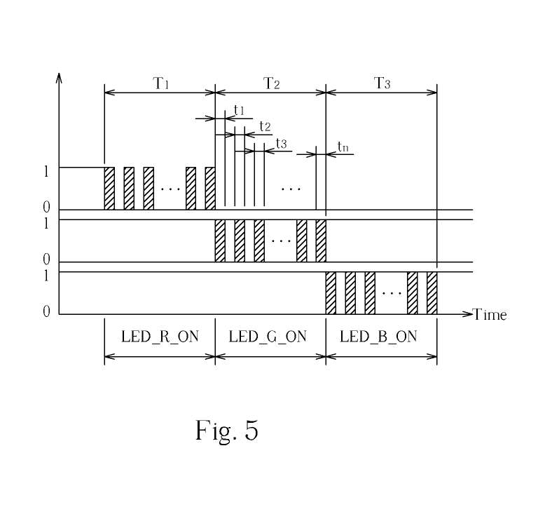

In Step 108, the system control board 58 is utilized to adjust the first PWM driving component 561, the second PWM driving component 562, and the third PWM driving component 563 in the PWM module 56 to control pulse widths of the corresponding red, green, and blue light pulse signal respectively for adjusting the luminous intensity of at least one LED in the RGB LEDs in the LED control board 54. And the pulse widths of the corresponding red, green, and blue light pulse signal are adjusted respectively based on the detecting signal (i.e. color temperature). For example, please refer to FIG. 5. If the luminous intensity of the green LED 545 is needed to decrease down to 50%, the pulse width (T₂) of the green light pulse signal generated by the second PWM driving component 562 can be adjusted down to 50% (equal to the sum from t₁ to tₙ) for controlling current flowing into the green LED 545 down to 50%. In such a manner, the luminous intensity of light generated by the green LED 545 will be decreased down to 50% so that the adjustment for color balance or brightness of light can be achieved.

The present invention utilizes the PWM module 56 to control the luminous intensity of an LED for adjusting color balance or brightness of light generated by the LED without changing the resistor. Therefore, when adjusting color balance or brightness of light, a user just needs to adjust the pulse width of the pulse signal output by the PWM module 56 instead of changing the resistor. Furthermore, the method according to the present invention also has higher precision than other prior art methods. For example, if the maximum tolerable current of an LED is 1 A, the PWM module can be fine-tuned with a pulse width corresponding to 1 mA.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A driving method for a light source system with LEDs comprising:
setting resistances of resistors in three driving circuits according to maximum tolerable currents corresponding to RGB LEDs respectively;
using a pulse width modulator module to drive the RGB LEDs respectively in turn with a frequency higher than a visual persistence frequency;
using a light sensor to detect light generated by the RGB LEDs and to output a detecting signal; and
controlling the pulse width modulator module to adjust a luminous intensity of at least one LED in the RGB LEDs according to the detecting signal.

2. The driving method of claim 1, wherein the pulse width modulator module outputs a pulse width modulator signal, the pulse width modulator module being utilized to control the pulse width of the pulse width modulator signal for adjusting the luminous intensity of at least one LED in the RGB LEDs.

3. The driving method of claim 2, wherein a system control board is utilized to adjust a first pulse width modulator driving component, a second pulse width modulator driving component, and a third pulse width modulator driving component in the pulse width modulator module to control pulse widths of the corresponding red light pulse signal, green light pulse signal, and blue light pulse signal respectively for adjusting the luminous intensity of at least one LED in the RGB LEDs.

4. The driving method of claim 1, wherein the light sensor detects the color temperatures of the light generated by the RGB LEDs and outputs the detecting signal according to the color temperatures.

5. A light source system comprising:
a power switch board for supplying power;
an LED control board electrically connected to the power switch board, the LED control board comprising a plurality of LEDs and a plurality of driving circuits, each driving circuit being used to input current into a corresponding LED for driving the plurality of LEDs;
a pulse width modulator module electrically connected to the LED control board, for outputting a pulse width modulator signal to the LED control board;
a system control board electrically connected to the pulse width modulator module, for controlling the pulse width modulator module to adjust the pulse width of the pulse width modulator signal; and
a light sensor electrically connected to the system control board, for detecting light generated by the plurality of LEDs and outputting a detecting signal to the system control board, the system control board controlling the pulse width modulator module to adjust the pulse width of the pulse width modulator signal according to the detecting signal.

6. The light source system of claim 5, wherein the plurality of LEDs comprises a red LED, a green LED, and a blue LED, and the plurality of driving circuits comprises a red LED driving circuit electrically connected to the red LED, a green LED driving circuit electrically connected to the green LED, and a blue LED driving circuit electrically connected to the blue LED.

7. The light source system of claim 5, wherein the pulse width modulator signal comprises a red light pulse signal, a green light pulse signal, and a blue light pulse signal, and the pulse width modulator module comprises a first pulse width modulator driving component for generating the red light pulse signal, a second pulse width modulator driving component for generating the green light pulse signal, and a third pulse width modulator driving component for generating the blue light pulse signal.

8. The light source system of claim 5, wherein each driving circuit comprises a resistor for controlling the magnitude of current flowing into the corresponding LED, the resistance of the resistor being set according to the maximum tolerable current of the corresponding LED.

9. The light source system of claim 5, wherein the plurality of LEDs are Power LEDs.
